(19) United States
(12) Patent Application Publication
(10) Pub. No.: US 2009/0049182 A1
(43) Pub. Date: Feb. 19, 2009

(54) AUTOMATIC TN3270 EMULATOR CONFIGURATION GENERATOR

(75) Inventor: Jesse L. Farinacci, Poughkeepsie, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/839,584

(22) Filed: Aug. 16, 2007

(51) Int. Cl. G06F 15/16

(52) U.S. Cl. 709/228

(57) ABSTRACT

Automatically generating TN3270 emulator configuration files for implementing communication sessions. A hardware master console (HMC) is data mined to determine a status for one or more data center mainframe entities that include one or more central processing centers (CPCs), sysplexes, logical partitions (LPARs), or various combinations thereof. The data mining also identifies one or more relationships between the data center mainframe entities. The one or more HMCs are periodically polled to update the status for the one or more data center mainframe entities. The updated status and the one or more identified relationships are incorporated into a graphical user interface that provides a navigational aid for navigating to each of a plurality of data center mainframe entities. Upon navigating to a data center mainframe entity of the plurality of data center mainframe entities, TN3270 emulator configuration files are dynamically generated for the data center mainframe entity using the updated status and the one or more identified relationships. The TN3270 emulator configuration files may be employed for use in implementing a single communication session, or to construct a set of TN3270 emulator configuration files for multiple communication sessions which may be unpacked for subsequent use.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to data communications and, more particularly, to systems, methods, and computer program products for automatically generating TN3270 emulator configuration files for implementing one or more communication sessions with a mainframe computer.

2. Description of Background

TN3270 emulation programs, such as IBM's Personal Communications, may be utilized to implement a communication session with a mainframe computer. For example, TN3270 allows personal computer (PC) users with a remote connection to a mainframe computer executing one or more 3270 applications. TN3270 can communicate with and control the PC as though the PC were a 3270 workstation, thus permitting an application that was originally written for use with a 3270 workstation to be used with the PC. A 3270 workstation is a terminal that has no on-board processing mechanism and must rely entirely on its attachment to a mainframe computer in order to process data. Although such workstations have been supplanted by PCs, many programs that were written for 3270 workstations remain in use, hence creating the need for 3270 emulators.

Currently, a system programmer is left to manually define, typically through a text editor or through the emulator itself, a plurality of TN3270 emulator configuration parameters for each z/OS logical partition (LPAR) in a system. This procedure may involve creating multiple configuration files for each LPAR since z/OS allows for multiple, customizable logical unit names and session types. For example, z/OS provides for use of master consoles, secondary master consoles, and multi-user timeshare (TSO) sessions. These configuration files are particularly sensitive to breaking should the LPAR be moved onto a different physical central processing center (CPC) since a TN3270 communication session needs to be aware of the correct Internet Protocol (IP) address for reaching file images stored on an LPAR.

A domain name system (DNS) may be utilized to avoid hard coding IP addresses in the configuration files. However, the nature of the DNS protocol requires that systems cache resolved IP addresses. This results in delays until such time as the cached canonical name to IP address mapping is invalidated. The time-to-live (TTL) value for invalidating IP address mapping is customarily measured in days. On the other hand, for many system implementations, data currency on the order of seconds is desired.

Another drawback to manual configuration is exposed when changes are made on a hardware master console (HMC) with respect to CPC/LPAR topology. Each system programmer must then make manual updates to his or her personal set of TN3270 emulator configuration files. In disruptive or fast-paced environments, the wake of these logical movements will result in configuration nightmares for system programmers. In one possible worst-case scenario, manual updates would be performed individually by each system programmer. A more organized facility might provide a central repository for communication sessions, but this would still require manual intervention by at least one person. The central repository approach also suffers from a “one size fits all” fallacy where individual users would be required to implement manual customizations, after the fact, on each configuration file to suit their own personal tastes.

In view of the foregoing, what is needed is an improved technique for automatically generating TN3270 emulator configuration files for implementing one or more communication sessions with a mainframe computer.

### SUMMARY OF THE INVENTION

Methods, computer program products, and systems provide automatically generated TN3270 emulator configuration files for implementing communication sessions. The configuration files are generated by data mining one or more hardware master consoles (HMCs) to determine a status for one or more data center mainframe entities that include one or more central processing centers (CPCs), sysplexes, logical partitions (LPARs), or various combinations thereof. The data mining also identifies one or more relationships between the data center mainframe entities. The one or more HMCs are periodically polled to update the status for the one or more data center mainframe entities. The updated status and the one or more identified relationships are incorporated into a graphical user interface that is accessible from any HTTP compatible web browser. The graphical user interface provides a navigational aid that permits navigating to each of a plurality of data center mainframe entities. Upon navigating to a data center mainframe entity of the plurality of data center mainframe entities, TN3270 emulator configuration files are dynamically generated for the data center mainframe entity using the updated status and the one or more identified relationships. The TN3270 emulator configuration files may be employed for use in implementing a single communication session, or to construct a set of TN3270 emulator configuration files for multiple communication sessions which may be unpacked for subsequent use.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary system for automatically generating TN3270 emulator configuration files.

FIG. 2 shows an illustrative graphical user interface for automatically generating customized TN3270 emulator configuration files in response to user input.

FIG. 3 illustrates an exemplary method for automatically generating TN3270 emulator configuration files.

The detailed description explains the preferred embodiments of the invention, together with advantages and features, by way of example with reference to the drawings.

### DETAILED DESCRIPTION OF THE INVENTION

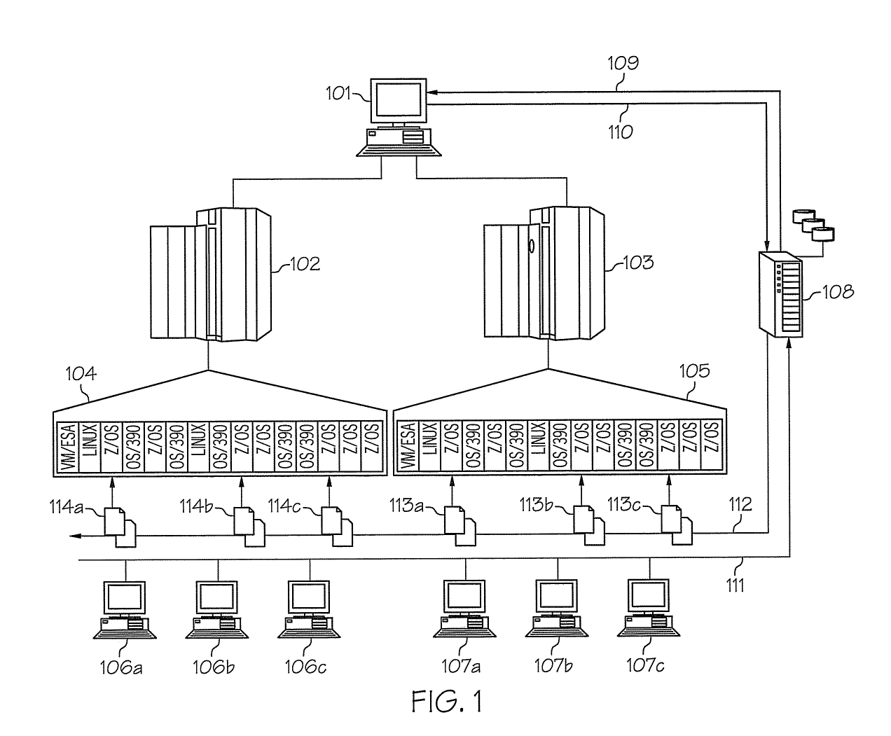

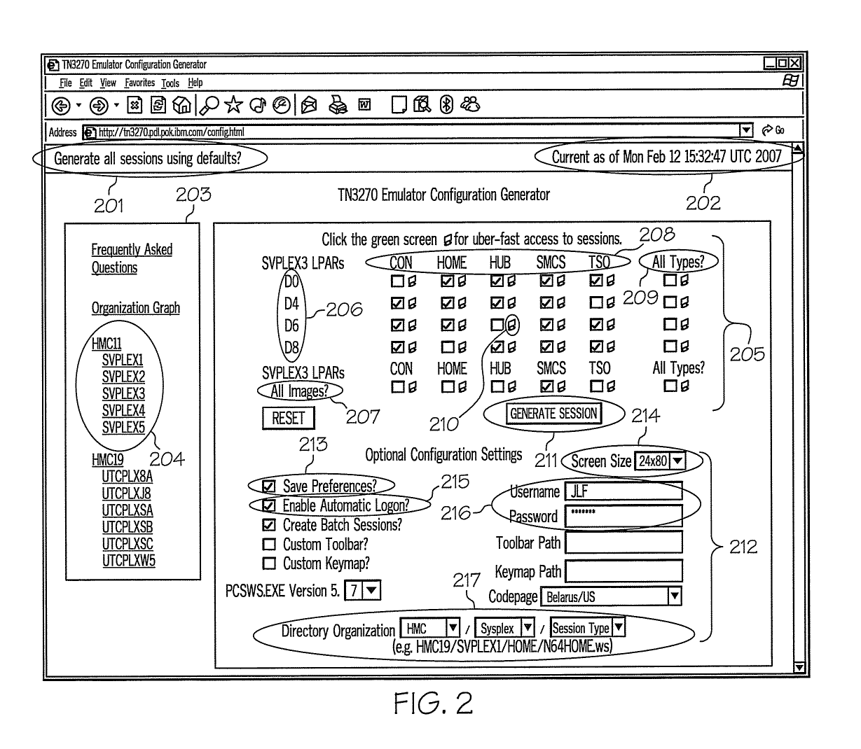

FIG. 1 illustrates an exemplary system for automatically generating TN3270 emulator configuration files. A hardware master console (HMC) 101 controls two central processing centers (CPCs) 102, 103. CPC 102 controls a plurality of logical partitions (LPARs) 104. LPARs 104 illustratively include z/OS and Linux images. Likewise, CPC 103 controls a plurality of LPARs 105 that illustratively include z/OS and Linux images. Three PCs 106a, 106b, and 106c are each equipped with a TN3270 emulation program that permits a user to connect to a single user-selected z/OS LPAR of LPARs 104 on a single CPC such as CPC 102, illustratively using the graphical user interface depicted in FIG. 2 (to be described in greater detail hereinafter). Returning to FIG. 1, three PCs 107a, 107b, 107c are each equipped with a TN3270 emulation program that permits a user to connect to a single user-selected z/OS LPAR of LPARs 105 on a single CPC such as CPC 103, illustratively using the graphical user interface depicted in FIG. 2. However, it should be clearly understood that six PCs 106a, 106b, 106c, 107a, 107b, and 107c are shown for illustrative purposes, as any number of one or more PCs could be provided.

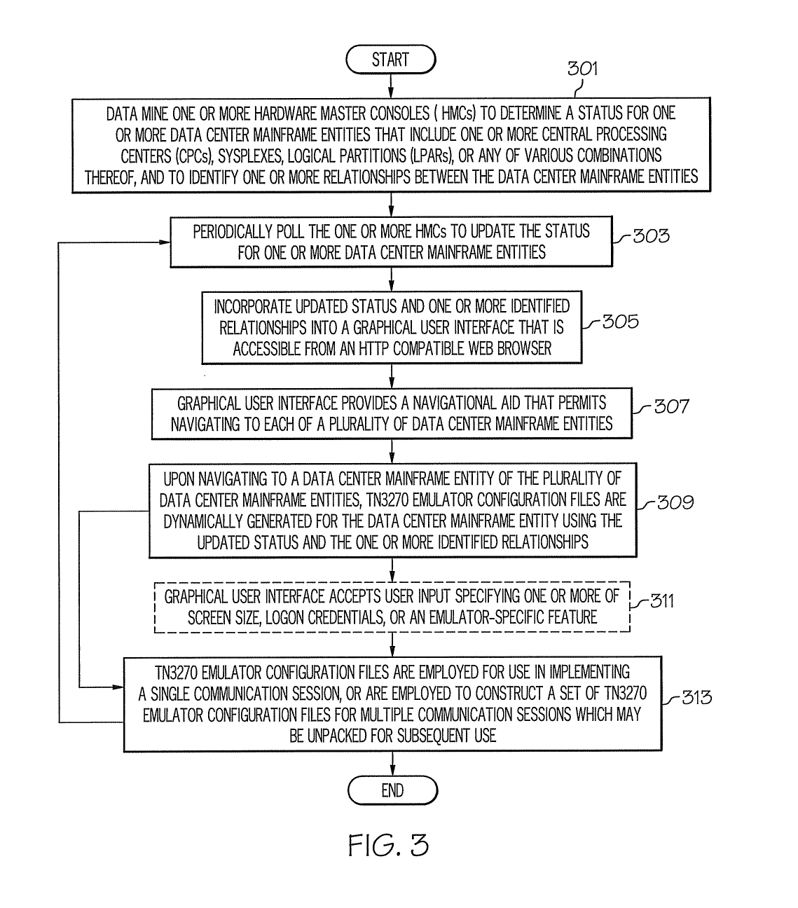

PCs 106a, 106b, 106c, 107a, 107b, 107c are operatively coupled to a server 108 over a communications link 111 and a communications link 112. Server 108 is programmed to implement the method shown in FIG. 3 (to be described in greater detail hereinafter). Server 108 is operatively coupled to HMC 101 over a communication link 109 and a communication link 110. Communication links 109, 110, 111, and 112 are illustratively implemented using a network such as the Internet, a private Intranet, an Ethernet link, a wide area network, (WAN), a local area network (LAN), a wireless network, or any of various combinations thereof. Server 108 interrogates one or more HMCs such as HMC 101 to dynamically generate TN3270 emulator configuration files, on demand, on a per-user basis, to any user wishing to communicate with image files on CPCs 102 or 103. Server 108 sends a periodic HTTP request, an on-demand HTTP request, or both, over communications link 109 to communicate with HMC 101 and interrogate HMC 101 about the entities under its control, such as CPCs 102, 103 and LPARs 104, 105. HMC 101 responds to an HTTP request received from server 108 by generating a data payload in the form of a list of all entities controlled by HMC 101, including one or more attributes for each entity. This data payload is sent to server 108 over communication link 110.

Any of PCs 106a, 106b, 106c, 107a, 107b, 107c may issue an on-demand HTTP request to communicate with server 108 over communications link 111 to generate a TN3270 emulator configuration file for a user-specified LPAR of LPARs 104, 105 on a particular CPC 102, 103. This HTTP request may be in the form of an HTTP GET or HTTP POST. In the case of an HTTP GET, any previously saved configuration options for this user will be applied to form a final TN3270 emulator configuration file. In the case of an HTTP POST, the request may include configuration options which take precedence over previously saved options.

In response to an on-demand HTTP request or a periodic HTTP request, server 108 transmits an HTTP response over communications link 112 to a PC which issued the request, such as one of PCs 106a, 106b, 106c, 107a, 107b, or 107c. The response includes a TN3270 emulator configuration file 114a for PC 106a, or a TN3270 emulator configuration file 114b for PC 106b, or a TN3270 emulator configuration file 114c for PC 106c, or a TN3270 emulator configuration file 113a for PC 107a, or a TN3270 emulator configuration file 113b for PC 107b, or a TN3270 emulator configuration file 113c for PC 107c, or any of various combinations thereof. Each of the TN3270 emulator configuration files 113a, 113b, 113c, 114a, 114b, and 114c may be provided in any of two forms: as a single file representing a configuration for a single communication session, or as a Zip file containing configuration information for a plurality of communication sessions. Each of the TN3270 emulator configuration files 113a, 113b, 113c, 114a, 114b, and 114c is used by a TN3270 emulator to connect to a single z/OS LPAR of LPARs 104, 105. Each TN3270 emulator configuration file contains all of the network configuration information necessary to establish a connection, as well as personal preference options as specified by default options or user controls.

FIG. 2 shows an illustrative web-based graphical user interface for automatically generating customized TN3270 emulator configuration files in response to user input. The graphical user interface may be utilized to generate a TN3270 emulator configuration file for a plurality of communication sessions. The graphical user interface provides a menu option 201 by which a user is able to specify use of default values or saved configuration options. A current data field 202 displays a time for which entity data for CPCs 102 or 103, or LPARs 104 or 105 (FIG. 1) held by server 108 is deemed to be accurate. This time may be based upon the time at which entity data were polled from CPCs 102 or 103, or LPARs 104 or 105. Accordingly, an end user can examine current data field 202 (FIG. 2) to determine whether or not server 108 (FIG. 1) is in sync with HMC 101.

The graphical user interface of FIG. 2 provides a navigation panel 203 for displaying each of one or more monitored HMCs (such as HMC 101, FIG. 1) and which CPCs 102, 103 are controlled by the one or more monitored HMCs. Each line in navigation panel 203 represents an HTML link which brings the user to a page to configure a particular sysplex. Alternatively, if an HMC name link is followed instead, it allows the user to configure all sysplexes for that HMC. Navigation links 204 are provided for one specific HMC, named HMC11, with five known sysplexes (SVPLEX1 through 5). Each underlined word is a link to a configuration page (shown for SVPLEX3), allowing individual LPAR and Session Type configuration.

The graphical user interface also provides an LPAR and Session Type selection matrix area 205. A sysplex/LPAR matrix 206 displays all known LPARs for SVPLEX3, one per row in the matrix. An All Images 207 checkbox allows a user to quickly select a particular Session Type for all of the known LPARs for this Sysplex. JavaScript may be employed as a usability enhancer such that, when a user toggles the All Images 207 checkbox, all corresponding LPARs (looking vertically) will also be enabled, or disabled, depending on the status of the All Images 207 checkbox selected. An all known session types field 208 displays session types for a corresponding HMC (HMC11, in this case). These Session Types represent different templates which are populated by both the data interrogated from one or more monitored HMCs, and also per-user configuration setting preferences. Session Type names will vary from facility to facility. The names, and corresponding templates, are all configured through XML and plain text. Each Session Type, among other attributes, can have an optional ‘connection macro’ which is invoked by most TN3270 emulators when a TCP/IP connection is established with the LPAR. This macro, itself a template which is filled in by the same manner as the configuration session, allows for complex tasks like automated user credential input for TSO sessions, to name just one example.

An All Types column 209 is provided which functions similarly to the All Images 207 checkbox previously described, with the exception that the All Types column 209 functions horizontally on Session Types instead of Images. Each Image/Session Type entry in the matrix has a corresponding green screen icon 210 next to a selection checkbox. This allows fast path generation of a single session, as represented by green screen icon 210, using default values with overrides by previously saved per-user preferences. In the case of a green screen icon 210 being clicked in the All Images or All Types area, then a Zip file will be created containing All Images for that session type, or All Types for that particular LPAR. This corresponds to the HTTP GET action described previously.

After selecting individual Image/Session Type entries à la carte, the user can specify configuration options in an optional configuration settings area 212. Optional configuration settings area 212 is an area of the graphical user interface which allows the user to customize the generated sessions on a per-user set of preferences. Once the process of customizing the finished generated TN3270 emulator configuration file output of the sessions is finished, the user submits the form to server 108 (FIG. 1) by clicking a ‘generate sessions!’ button 211. This corresponds to the HTTP POST action described previously. After form submission, a single session or Zip file of sessions will be created and sent back to the user. In the former case, the server will write the actual session with a proper HTTP Content-Disposition header for the particular TN3270 emulator for which it is developing a configuration. This allows for the user to have a web browser preference of automatically launching the TN3270 emulator using the generated session. In the case of a Zip archive, the page will automatically initiate a download for the generated archive file. In both cases, the user will remain on the configuration page which originated the request.

A save preferences 213 button is provided which enables a user to toggle whether or not they wish to employ an HTTP cookie to allow the server to “remember” the user's preferences for subsequent visits to the application. A screen size 214 button is a configuration option that provides users with a wide variety of preferences for screen size, this allows the setting of that field in the generated configuration session file. An optional enable automatic logon 215 button may be provided if the underlying TN3270 emulator application supports the use of a ‘connection macro’. The user may optionally specify logon credentials to be applied to the macro template which would be invoked for certain Session Types, e.g. the TSO type. Optional text area 216 is provided for the user to enter their logon credentials. The password field is optional in that if left unspecified, the connection macro should only enter the user name portion, allowing the actual user to complete the logon process manually. This feature is to satisfy common corporate security guidelines.

When a Zip archive is generated, there will often be an overwhelming number of TN3270 configuration session files. Accordingly, a directory organization 217 setting allows the user to set up a configurable file system hierarchy under which the communication sessions will be generated. In this particular example, all generated sessions will be sorted by HMC name, with subdirectories for each sysplex name, which then contains subdirectories for each Session Type. Organizing sessions into this default format allows for quickly finding the correct Image/Session type for large raised floor environments.

FIG. 3 illustrates an exemplary method for automatically generating TN3270 emulator configuration files for implementing communication sessions. The procedure commences at block 301 where configuration files are generated by data mining one or more hardware master consoles (HMCs such as HMC 101, FIG. 1) to determine a status for one or more data center mainframe entities that include one or more central processing centers (CPCs 102, 103), sysplexes, logical partitions (LPARs 104, 105), or various combinations thereof. The data mining also identifies one or more relationships between the data center mainframe entities. Next, at block 303 (FIG. 3). the one or more HMCs are periodically polled to update the status for the one or more data center mainframe entities. The updated status and the one or more identified relationships are incorporated into a graphical user interface (FIG. 2) that is accessible from any HTTP compatible web browser (FIG. 3, block 305). The graphical user interface provides a navigational aid that permits navigating to each of a plurality of data center mainframe entities (block 307). Upon navigating to a data center mainframe entity of the plurality of data center mainframe entities, TN3270 emulator configuration files are dynamically generated for the data center mainframe entity using the updated status and the one or more identified relationships (block 309). Optionally, the graphical user interface accepts user input specifying one or more of screen size, logon credentials, or an emulator-specific feature (block 311). The TN3270 emulator configuration files may be employed for immediate use in implementing a single communication session, or to construct a set of TN3270 emulator configuration files for multiple communication sessions which may be unpacked for subsequent use (block 313).

Illustratively, the procedure of FIG. 3 may be utilized to implement any of the following two scenarios: (a) one time generation, locally persistent configuration and support files, or (b) on demand generation, optional locally persistent support files only, or both. Pursuant to scenario (a), a user wants to keep all TN3270 emulator configuration files locally on her computer. The user will set up her configuration file preferences (screen size, logon credentials, and other TN3270 emulator specific features) and save them to the server. Then she will either use the ‘generate all sessions’ HTTP GET request, or choose All Images/All Types for each sysplex she is interested in. The server will build a Zip archive, which she will unpack onto her local computer. All support files, such as connection macros, will be installed, and the user will then launch the TN3270 emulator using the local files.

Considering scenario (b), a user wishes to generate all TN3270 emulator configuration files on demand, whenever the user requires a new TN3270 session. Optionally, to take advantage of all per-TN3270 emulator features, like connection macros, the user will set up her configuration file preferences and save them to the server. Then she will ‘generate all sessions’ and unpack the generated Zip archive onto her local computer. She will install all support files, but from then on out, will utilize the web application front end to dynamically generate single use sessions. No local installation is required, but the user will not benefit from any TN3270 emulator specific features requiring ‘connection macros’, and such. This use case is encouraged, because it offers the highest level of flexibility for the end user. TN3270 emulator configuration files are always up to date, and reflect the current topology of the raised floor. Furthermore, it allows the user to take advantage of all the advanced functionality of the specific TN3270 emulator in use, for example automatic logon.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method for providing automatically generated TN3270 emulator configuration files for implementing one or more communication sessions, the method comprising:
data mining one or more hardware master consoles (HMCs) to determine a status for one or more data center mainframe entities that include one or more central processing centers (CPCs), sysplexes, logical partitions (LPARs), or various combinations thereof, wherein the data mining also identifies one or more relationships between the data center mainframe entities;
periodically polling the one or more HMCs to update the status for the one or more data center mainframe entities;
incorporating the updated status and the one or more identified relationships into a graphical user interface that is accessible from any HTTP compatible web browser, wherein the graphical user interface provides a navigational aid that permits navigating to each of a plurality of data center mainframe entities such that, upon navigating to a data center mainframe entity of the plurality of data center mainframe entities, TN3270 emulator configuration files are dynamically generated for the data center mainframe entity using the updated status and the one or more identified relationships.

2. The method of claim 1 wherein the generated TN3270 emulator configuration files are employed for use in implementing a single communication session.

3. The method of claim 1 further comprising generating a TN3270 emulator configuration file for multiple communication sessions wherein the file is unpacked for subsequent use.

4. The method of claim 1 wherein the graphical user interface provides a matrix of LPARs and a plurality of communication session types for selecting generation of a TN3270 emulator configuration file.

5. The method of claim 1 wherein the graphical user interface accepts user input specifying a display screen size.

6. The method of claim 1 wherein the graphical user interface accepts one or more logon credentials for a user.

7. The method of claim 1 wherein the graphical user interface accepts a user input that initiates transmission of at least one of an HTTP GET action or an HTTP POST action.

8. A computer program product for providing automatically generated TN3270 emulator configuration files for implementing one or more communication sessions, the computer program product comprising a computer readable storage medium for storing instructions which, when executed on a computer, causes the computer to perform a method comprising:
data mining one or more hardware master consoles (HMCs) to determine a status for one or more data center mainframe entities that include one or more central processing centers (CPCs), sysplexes, logical partitions (LPARs), or various combinations thereof, wherein the data mining also identifies one or more relationships between the data center mainframe entities;
periodically polling the one or more HMCs to update the status for the one or more data center mainframe entities;
incorporating the updated status and the one or more identified relationships into a graphical user interface that is accessible from any HTTP compatible web browser, wherein the graphical user interface provides a navigational aid that permits navigating to each of a plurality of data center mainframe entities such that, upon navigating to a data center mainframe entity of the plurality of data center mainframe entities, TN3270 emulator configuration files are dynamically generated for the data center mainframe entity using the updated status and the one or more identified relationships.

9. The computer program product of claim 8 wherein the generated TN3270 emulator configuration files are employed for use in implementing a single communication session.

10. The computer program product of claim 8 further comprising generating a TN3270 emulator configuration file for multiple communication sessions wherein the file is unpacked for subsequent use.

11. The computer program product of claim 8 wherein the graphical user interface provides a matrix of LPARs and a plurality of communication session types for selecting generation of a TN3270 emulator configuration file.

12. The computer program product of claim 8 wherein the graphical user interface accepts user input specifying a display screen size.

13. The computer program product of claim 8 wherein the graphical user interface accepts one or more logon credentials for a user.

14. The computer program product of claim 8 wherein the graphical user interface accepts a user input that initiates transmission of at least one of an HTTP GET action or an HTTP POST action.

15. A system for providing automatically generated TN3270 emulator configuration files for implementing one or more communication sessions, the system comprising:
a monitoring mechanism for data mining one or more hardware master consoles (HMCs) to determine a status for one or more data center mainframe entities that include one or more central processing centers (CPCs), sysplexes, logical partitions (LPARs), or various combinations thereof, wherein the monitoring mechanism also identifies one or more relationships between the data center mainframe entities, and wherein the monitoring mechanism is capable of periodically polling the one or more HMCs to update the status for the one or more data center mainframe entities;
a graphical user interface, operatively coupled to the monitoring mechanism, wherein the updated status and the one or more identified relationships are incorporated into the graphical user interface, wherein the graphical user interface is accessible from any HTTP compatible web browser, and wherein the graphical user interface provides a navigational aid that permits navigating to each of a plurality of data center mainframe entities such that, upon navigating to a data center mainframe entity of the plurality of data center mainframe entities, TN3270 emulator configuration files are dynamically generated for the data center mainframe entity using the updated status and the one or more identified relationships.

16. The system of claim 15 wherein the generated TN3270 emulator configuration files are employed for use in implementing a single communication session.

17. The system of claim 15 wherein a TN3270 emulator configuration file is generated for multiple communication sessions, and wherein the file is unpacked for subsequent use.

18. The system of claim 15 wherein the graphical user interface provides a matrix of LPARs and a plurality of communication session types for selecting generation of a TN3270 emulator configuration file.

19. The system of claim 15 wherein the graphical user interface accepts user input specifying a display screen size.

20. The system of claim 15 wherein the graphical user interface accepts one or more logon credentials for a user.

21. The system of claim 15 wherein the graphical user interface accepts a user input that initiates transmission of at least one of an HTTP GET action or an HTTP POST action.
